(19) United States
(12) Patent Application Publication
(10) Pub. No.: US 2014/0202279 A1
(43) Pub. Date: Jul. 24, 2014

(54) TRANSMISSION FOR A VEHICLE

(71) Applicant: GM GLOBAL TECHNOLOGY OPERATIONS LLC, Detroit, MI (US)

(72) Inventors: Konstantinos Triantos, Huntington Beach, CA (US); John A. Diemer, Farmington Hills, MI (US); Pete R. Garcia, Troy, MI (US); Kent A. Miller, Pinckney, MI (US); Anthony P. Tata, Fenton, MI (US)

(73) Assignee: GM GLOBAL TECHNOLOGY OPERATIONS LLC, Detroit, MI (US)

(21) Appl. No.: 13/745,006

(22) Filed: Jan. 18, 2013

(51) Int. Cl. F16H 39/00

(52) U.S. Cl. CPC F16H 39/00
USPC 74/606 R

(57) ABSTRACT

A transmission for a vehicle is disclosed. The transmission includes a casing. The casing includes a base and a plurality of walls extending outwardly away from the base to a distal edge. The casing defines a first cavity and a second cavity between the walls. The transmission also includes a platform disposed between the walls to separate the first and second cavities. The first cavity is disposed adjacent to the distal edge of each of the walls. The transmission further includes a power inverter module defining a self-contained unit selectively disposed in the first cavity. The self-contained unit is supported by the platform when in the first cavity.

### TECHNICAL FIELD

The present disclosure relates to a transmission for a vehicle.

### BACKGROUND

Various transmissions have been developed for vehicles. One type of transmission is an electrically-variable transmission including two electric motor/generators, clutches, etc. Clutches allow one or more electrically-variable modes of operation, such as fixed speed ratio modes, and an electric-only (battery-powered) mode. An electric power inverter assembly is utilized to control the first and second electric motor/generators. Generally, the electric power inverter assembly is assembled remote from the electrically-variable transmission; therefore, assembly of the electric power inverter is labor intensive and additional brackets or supports are generally utilized to secure the electric power inverter assembly remote from the transmission.

### SUMMARY

The present disclosure provides a transmission for a vehicle. The transmission includes a casing. The casing includes a base and a plurality of walls extending outwardly away from the base to a distal edge. The casing defines a first cavity and a second cavity between the walls. The transmission also includes a platform disposed between the walls to separate the first and second cavities. The first cavity is disposed adjacent to the distal edge of each of the walls. The transmission further includes a power inverter module defining a self-contained unit selectively disposed in the first cavity. The self-contained unit is supported by the platform when in the first cavity.

The present disclosure also provides a transmission for a vehicle. The transmission includes a casing. The casing includes a base and a plurality of walls extending outwardly away from the base to a distal edge. The casing defines a first cavity and a second cavity between the walls. The walls include an exterior disposed outside of the casing. The second cavity is configured for receiving transmission fluid to define a wet interior. The first cavity is generally disposed above the second cavity for maintaining the transmission fluid in the second cavity such that the first cavity defines a dry interior. The transmission also includes a platform disposed between the walls to separate the first and second cavities. The first cavity is disposed adjacent to the distal edge of each of the walls such that the first cavity is selectively open to the exterior of the walls and the second cavity is closed to the exterior of the walls. The transmission further includes a power inverter module defining a self-contained unit selectively disposed in the first cavity. The self-contained unit is supported by the platform when in the first cavity. The transmission also includes a lid movable between a first position attached to the distal edge of each of the walls for containing the power inverter module in the first cavity of the casing and a second position detached from the distal edge of each of the walls for removing the power inverter module from the first cavity of the casing as the self-contained unit.

The detailed description and the drawings or Figures are supportive and descriptive of the disclosure, but the scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic side view of a transmission with a first cable harness and a wire harness exploded from the transmission.

FIG. 2 is a schematic partially exploded perspective view of the transmission.

FIG. 3 is a schematic perspective broken view of a casing with a pump, a first motor/generator and a second motor/generator each disposed in a second cavity.

FIG. 4 is a schematic top perspective view of a power inverter module disposed in a first cavity with a lid removed.

FIG. 5 is a schematic bottom perspective broken view of the power inverter module.

FIG. 6 is a schematic of a first junction in communication with a first inverter, a second inverter and a third inverter, with the first inverter in communication with the first motor/generator, and with the second inverter in communication with the second motor/generator, and with the third inverter in communication with a motor of the pump.

FIG. 7 is a schematic of a connection plug in communication with a controller, and with the controller in communication with the first, second and third inverters.

### DETAILED DESCRIPTION

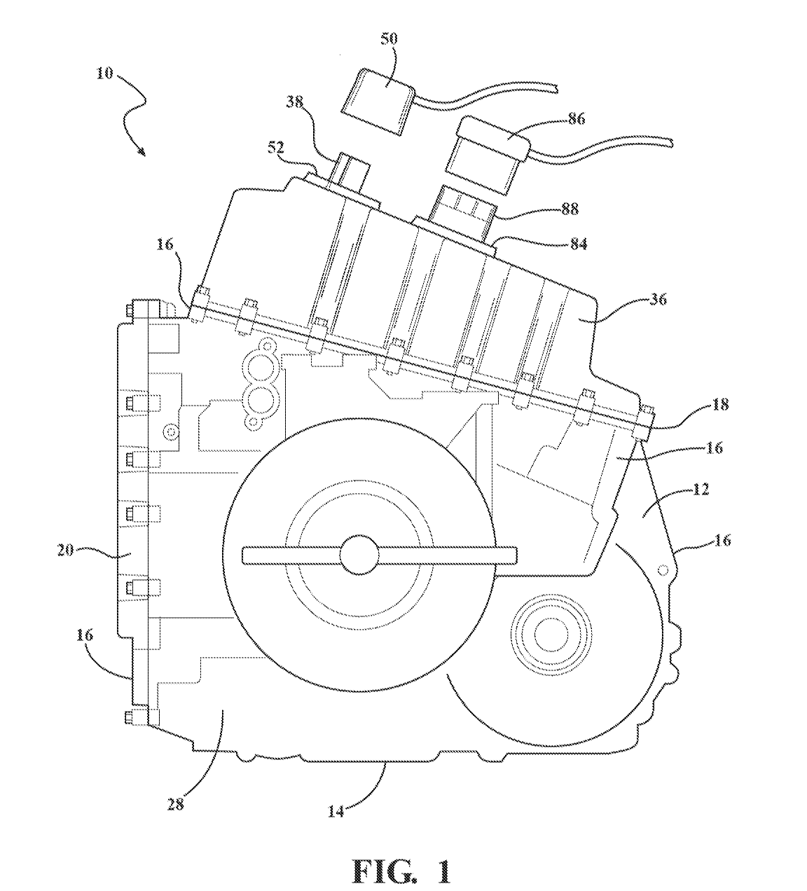

Referring to the Figures, wherein like numerals indicate like or corresponding parts throughout the several views, a transmission 10 for a vehicle is generally shown in FIG. 1. The transmission 10 can be an electrically-variable transmission 10 as discussed further below or any other suitable transmission 10. Therefore, the transmission 10 discussed herein can be for a hybrid vehicle or any other suitable vehicle.

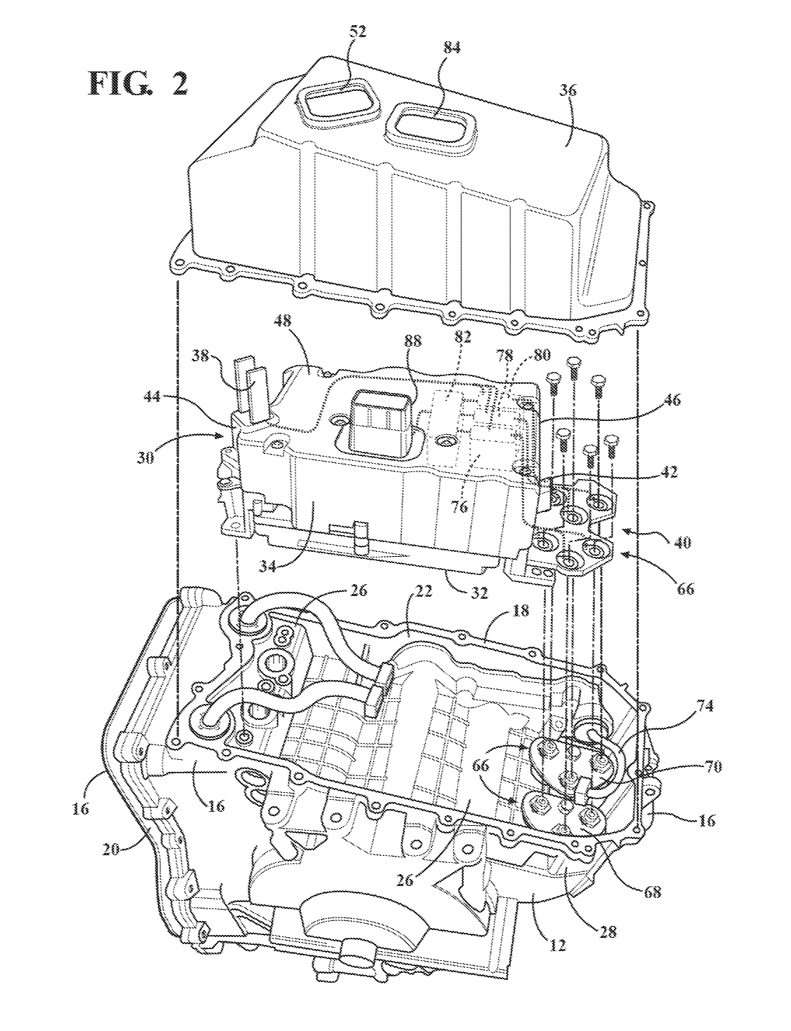

The transmission 10 includes a casing 12 as best shown in FIGS. 1 and 2. The casing 12 includes a base 14 and a plurality of walls 16 extending outwardly away from the base 14 to a distal edge 18. In certain embodiments, one or more walls 16 are integrally formed to the base 14. In other words, one or more walls 16 and the base 14 can be formed of one piece. Furthermore, in certain embodiments, a segment 20 of at least one of the walls 16 can be detachable from the other walls 16.

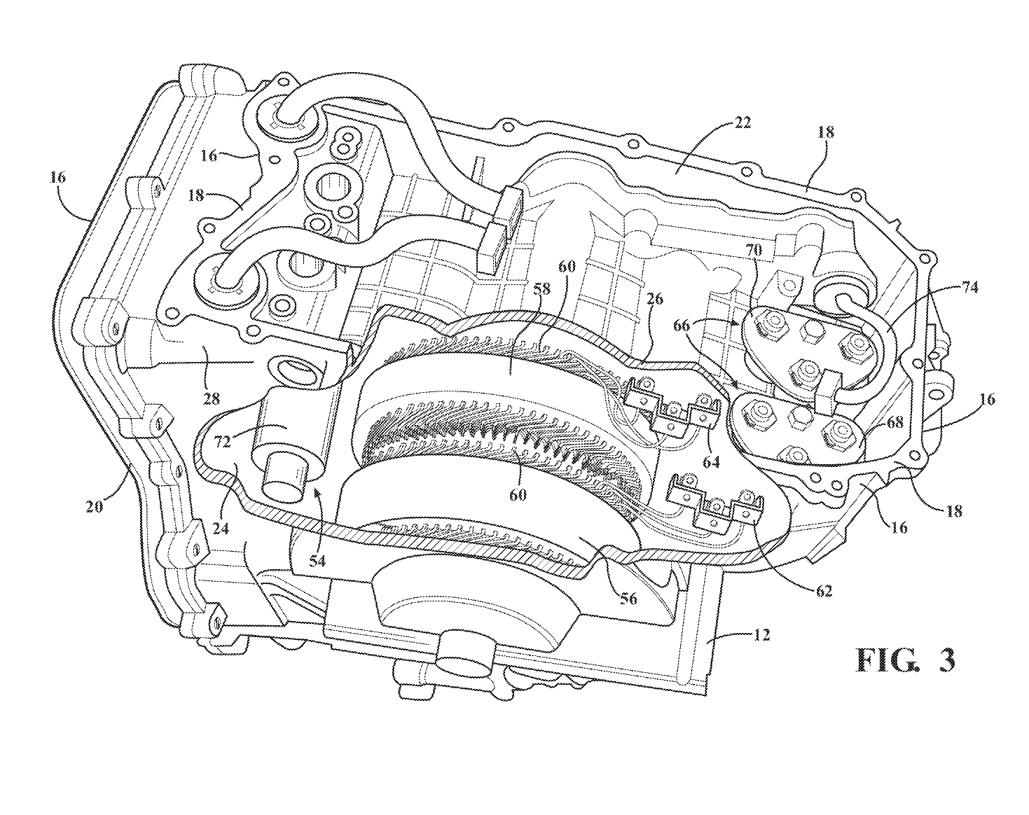

Referring to FIGS. 2 and 3, the casing 12 defines a first cavity 22 and a second cavity 24 between the walls 16. Generally, the first cavity 22 is disposed adjacent to the distal edge 18 of each of the walls 16. Furthermore, the first and second cavities 22, 24 are spaced from each other.

Continuing with FIGS. 2 and 3, in addition, the transmission 10 includes a platform 26 disposed between the walls 16 to separate the first and second cavities 22, 24. Generally, at least a portion of the platform 26 is disposed inside the casing 12.

The casing 12, and more specifically, the walls 16 can include an exterior 28 disposed outside of the casing 12. The first cavity 22 is generally disposed adjacent to the distal edge 18 of each of the walls 16 such that the first cavity 22 is selectively open to the exterior 28 of the walls 16 and the second cavity 24 is substantially closed to the exterior 28 of the walls 16. Specifically, in certain embodiments, the first cavity 22 is disposed above the second cavity 24 such that the platform 26 and the walls 16 cooperate to substantially close the second cavity 24.

The first cavity 22 is configured for receiving a gaseous fluid to define a dry interior. In certain embodiments, the gaseous fluid in the first cavity 22 is air. It is to be appreciated that other gaseous fluids can be disposed in the first cavity 22.

Furthermore, the second cavity 24 is configured for receiving a liquid fluid to define a wet interior. In certain embodiments, the liquid fluid in the second cavity 24 is transmission fluid. Therefore, in certain embodiments, the second cavity 24 is configured for receiving transmission fluid to define the wet interior. For example, the transmission fluid can be automatic transmission fluid (ATF). It is to be appreciated that other liquid fluids can be disposed in the second cavity 24.

The first cavity 22 is generally disposed above the second cavity 24 for maintaining the liquid fluid in the second cavity 24 such that the first cavity 22 defines the dry interior. In other words, the first cavity 22 is generally disposed above the second cavity 24 for maintaining the transmission fluid in the second cavity 24. More specifically, the first cavity 22 is generally disposed above the second cavity 24 for maintaining the transmission fluid in the second cavity 24 such that the first cavity 22 defines the dry interior. Furthermore, the platform 26 separates the first and second cavities 22, 24 to assist in maintaining the liquid fluid in the second cavity 24.

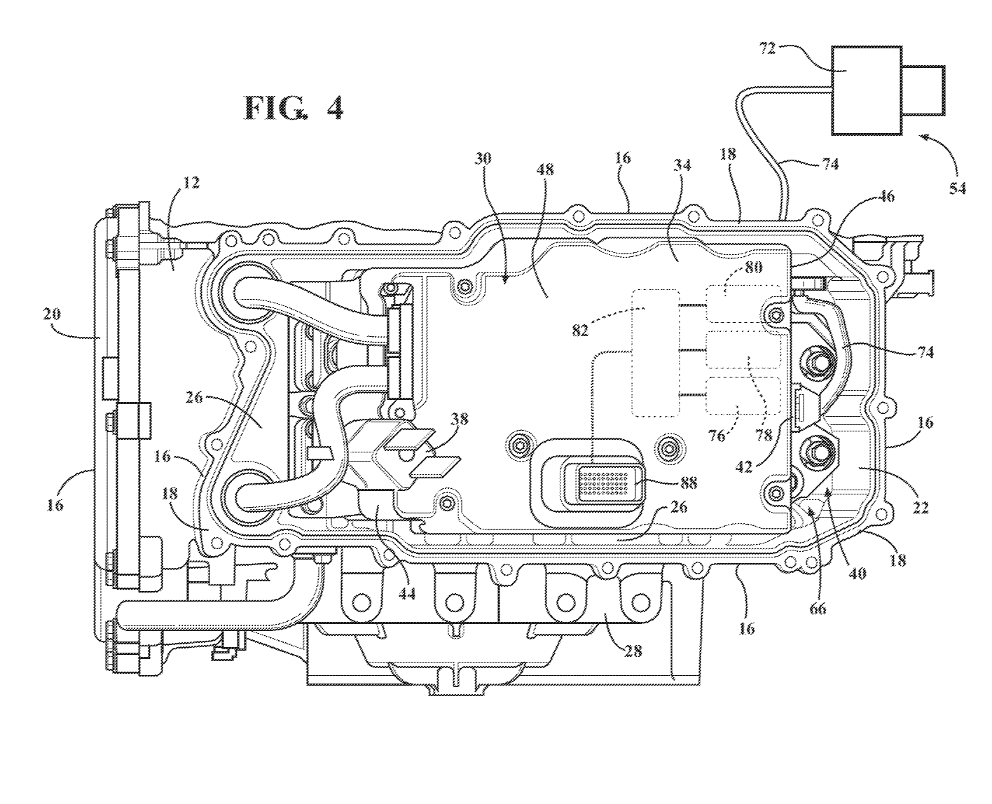

Referring to FIGS. 2 and 4, the transmission 10 further includes a power inverter module 30 defining a self-contained unit selectively disposed in the first cavity 22. Generally, the self-contained unit is supported by the platform 26 when in the first cavity 22. Packaging the power inverter module 30 as the self-contained unit provides a compact design, as well as provides easy assembly of the power inverter module 30 to the transmission 10 and easy disassembly of the power inverter module 30 from the transmission 10. Therefore, the power inverter module 30 is self-contained to be dropped into the first cavity 22 as a unit and integrated into the transmission 10, thus simplifying assembly. Furthermore, the power inverter module 30 is self-contained to allow easy replacement of the power inverter module 30 with another power inverter module 30. In addition, the power inverter module 30 is disposed in the first cavity 22 which defines the dry interior to separate the power inverter module 30 from the liquid fluid in the second cavity 24. It is to be appreciated that the power inverter module 30 can also be referred to as a traction power inverter module (TPIM).

In certain embodiments, the power inverter module 30 can include a bottom 32 selectively coupled to the platform 26 and a cover 34 coupled to the bottom 32. The bottom 32 and the cover 34 cooperate to further define the self-contained unit. In other words, the base 14 and the cover 34 cooperate to define a hollow therein, with various components of the power inverter module 30 disposed in the hollow, some of which are discussed further below.

The bottom 32 of the power inverter module 30 can be coupled or attached to the platform 26 to secure the power inverter module 30 to the platform 26, and more specifically, to position the power inverter module 30 relative to the walls 16 in the first cavity 22. Therefore, uncoupling or detaching the bottom 32 of the power inverter module 30 from the platform 26 allows the self-contained unit to be easily removed and replaced by another power inverter module 30.

The transmission 10 can also include a lid 36 attached to the casing 12 to contain the power inverter module 30 inside the first cavity 22. More specifically, the lid 36 can be attached to the distal edge 18 of each of the walls 16. The lid 36 is movable between a first position attached to the distal edge 18 of each of the walls 16 for containing the power inverter module 30 in the first cavity 22 of the casing 12 and a second position detached from the distal edge 18 of each of the walls 16 for removing the power inverter module 30 from the first cavity 22 of the casing 12 as the self-contained unit. Therefore, generally, the lid 36 is disposed in the first position when attached to the casing 12 and the lid 36 is disposed in the second position when detached from the casing 12. The lid 36 is shown in the first position in FIG. 1 and the lid 36 is shown in the second position in FIG. 2.

When the lid 36 is in the first position, the power inverter module 30 can be closed or sealed in the first cavity 22 such that the first cavity 22 remains dry to define the dry interior. It is to be appreciated that any suitable seal, gasket, etc. can be disposed between the distal edge 18 of each of the walls 16 and the lid 36 to assist in closing or sealing the first cavity 22 when the lid 36 is in the first position. Therefore, engagement between the lid 36 and the distal edge 18 of each of the walls 16 minimizes fluids, particles, etc. from entering the first cavity 22 from outside the casing 12.

Generally, the power inverter module 30 is configured for providing electrical energy to various components, some of which are discussed further below. Specifically, the power inverter module 30 is configured for converting direct current energy into alternating current energy. Therefore, the power inverter module 30 converts direct current energy into alternating current energy for various components, some of which are discussed further below.

Turning to FIGS. 2 and 4, the power inverter module 30 can include a first junction 38 for receiving the direct current energy into the self-contained unit. Furthermore, the power inverter module 30 can include a second junction 40 and a third junction 42 each for outputting the alternating current energy from the self-contained unit. Generally, the first, second and third junctions 38, 40, 42 are spaced from each other.

Turning to FIG. 2, the cover 34 of the power inverter module 30 can include a front side 44 and a rear side 46 opposing the front side 44. The cover 34 can also include a top side 48 disposed between the front and rear sides 44, 46 and opposing the bottom 32 of the power inverter module 30. At least one of the first, second and third junctions 38, 40, 42 extend from one of the rear and top sides 46, 48. Specifically, in certain embodiments, the first junction 38 extends from the top side 48 and the second and third junctions 40, 42 extend from the rear side 46. It is to be appreciated that the first, second and third junctions 38, 40, 42 can extend from any suitable side, including the front, rear and top sides 44, 46, 48 as discussed above, of the power inverter module 30.

Generally, a first cable harness 50 (see FIG. 1) is coupled to the first junction 38 for delivering or supplying the direct current energy into the power inverter module 30. Therefore, the direct current energy from the first cable harness 50 is delivered into the power inverter module 30 through the first junction 38 and converted into the alternating current energy which exits the power inverter module 30 through the second and third junctions 40, 42. In other words, the alternating current energy is outputted from the power inverter module 30 through the second and third junctions 40, 42.

In certain embodiments, the lid 36 defines a first opening 52 (see FIG. 2) cooperating with the first junction 38 such that the first cable harness 50 can engage the first junction 38. Specifically, the first cable harness 50 generally closes or seals the lid 36 about the first opening 52 to minimize fluids, particles, etc. from entering the first cavity 22 from outside of the lid 36. It is to be appreciated that other components can be utilized to close or seal the lid 36 about the first opening 52, such as, for example, seals, gaskets, caps, etc.

Turning to FIGS. 3 and 4, the transmission 10 can further include at least one of a pump 54 and a first motor/generator 56 electrically connected to one of the second and third junctions 40, 42 of the power inverter module 30 such that the alternating current energy is delivered or supplied to at least one of the pump 54 and the first motor/generator 56. In certain embodiments, the first motor/generator 56 is electrically connected to the second junction 40 of the power inverter module 30 and the pump 54 is electrically connected to the third junction 42 such that the alternating current energy is delivered to both the first motor/generator 56 and the pump 54.

Referring to FIG. 3, the first motor/generator 56 is disposed in the second cavity 24, and the transmission 10 can further include a second motor/generator 58 disposed in the second cavity 24. In other words, the first and second motor/generators 56, 58 are each disposed in the second cavity 24. In certain embodiments, the first and second motor/generators 56, 58 are each electrically connected to the second junction 40 of the power inverter module 30 such that the alternating current energy is delivered or supplied to the first and second motor/generators 56, 58. Therefore, the direct current energy from the first cable harness 50 is delivered into the power inverter module 30 through the first junction 38 and converted into the alternating current energy which exits the power inverter module 30 through the second junction 40 such that the alternating current energy is delivered to the first and second motor/generators 56, 58.

Generally, the first and second motor/generators 56, 58 can each include a rotor and a stator 60. In various embodiments, the first and/or second motor/generators 56, 58 can be referred to as traction motors. The first motor/generator 56 includes a first terminal 62 coupled to the second junction 40. The first terminal 62 is coupled to the stator 60 of the first motor/generator 56 to electrically connect the stator 60 of the first motor/generator 56 and the power inverter module 30 to each other. In addition, the second motor/generator 58 includes a second terminal 64 coupled to the second junction 40. The second terminal 64 is coupled to the stator 60 of the second motor/generator 58 to electrically connect the stator 60 of the second motor/generator 58 and the power inverter module 30 to each other. FIG. 3 illustrates the first and second terminals 62, 64 uncoupled from the second junction 40 for illustrative purposes only.

Referring to FIGS. 2 and 3, specifically, an interface assembly 66 electrically connects the power inverter module 30 to the first and second motor/generators 56, 58. The interface assembly 66 includes the second junction 40, as well as a first bundle 68 and a second bundle 70 each disposed through the platform 26. Therefore, part of the first bundle 68 is disposed in the first cavity 22 to couple to the second junction 40 and another part of the first bundle 68 is disposed in the second cavity 24 to couple to the first terminal 62. Similarly, part of the second bundle 70 is disposed in the second cavity 24 to couple to the second junction 40 and another part of the second bundle 70 is disposed in the second cavity 24 to couple to the second terminal 64. FIG. 3 illustrates the first and second terminals 62, 64 uncoupled from the first and second bundles 68, 70 respectively for illustrative purposes only.

Generally, the electrically-variable transmission 10 can include the first and second motor/generators 56, 58 as discussed above. As implied above, the electrically-variable transmission 10 can be utilized in hybrid vehicles. Therefore, the power inverter module 30 is utilized to supply the alternating current energy to the first and second motor/generators 56, 58, as well as to control the first and second motor/generators 56, 58 as discussed further below. It is to be appreciated that the transmission 10 can include other components not specifically discussed herein. It is to also be appreciated that the transmission 10 can be utilized for vehicles other than hybrid vehicles as also discussed above.

In various embodiments, the transmission 10 can include the pump 54 and the first and second motor/generators 56, 58. In one embodiment, the pump 54 can be disposed in the second cavity 24 of the transmission 10 (see FIG. 3). Turning to FIG. 4, the pump 54 can include a motor 72 electrically connected to the third junction 42 of the power inverter module 30 such that the alternating current energy is delivered or supplied to the motor 72 of the pump 54. More specifically, the direct current energy from the first cable harness 50 is delivered into the power inverter module 30 through the first junction 38 and converted into the alternating current energy which exits the power inverter module 30 through the third junction 42 such that the alternating current energy is delivered to the pump 54, and specifically, to the motor 72 of the pump 54. A second cable harness 74 (see FIG. 4) can be coupled to the third junction 42 and the motor 72 of the pump 54 to deliver the alternating current energy from the power inverter module 30 to the pump 54. It is to be appreciated that the first and second motor/generators 56, 58 are shown schematically in FIG. 3 for illustrative purposes and the configuration/location of the first and second motor/generators 56, 58 can change. Furthermore, it is to be appreciated that the pump 54 is shown schematically in FIGS. 3 and 4 for illustrative purposes only and the configuration/location of the pump 54 can change.

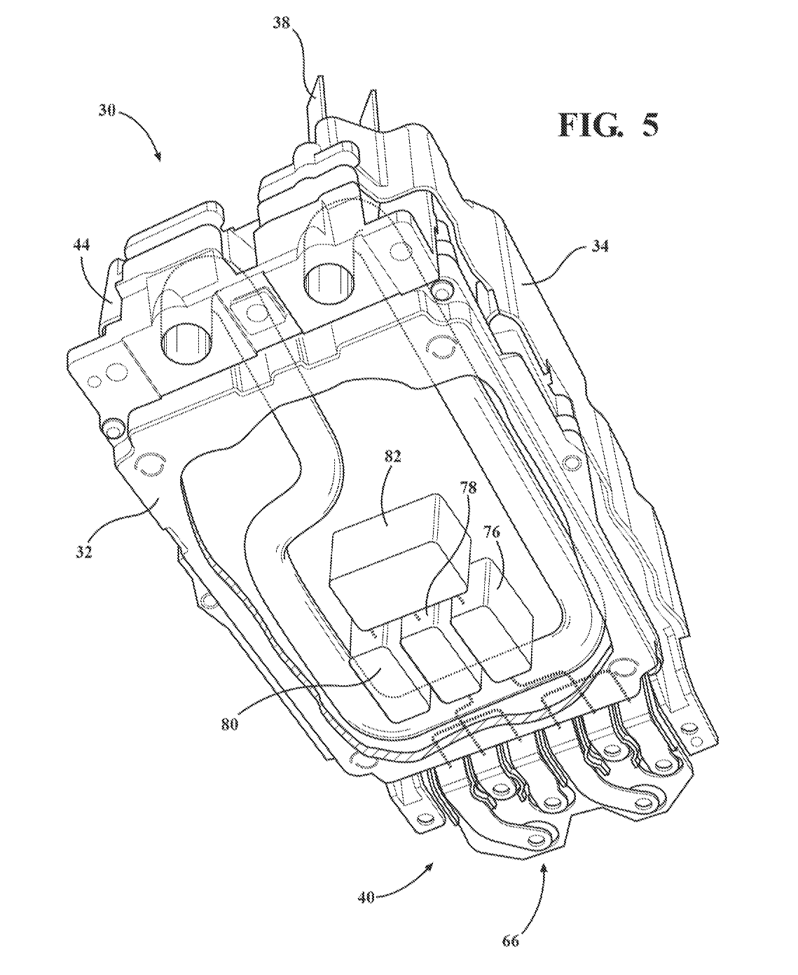

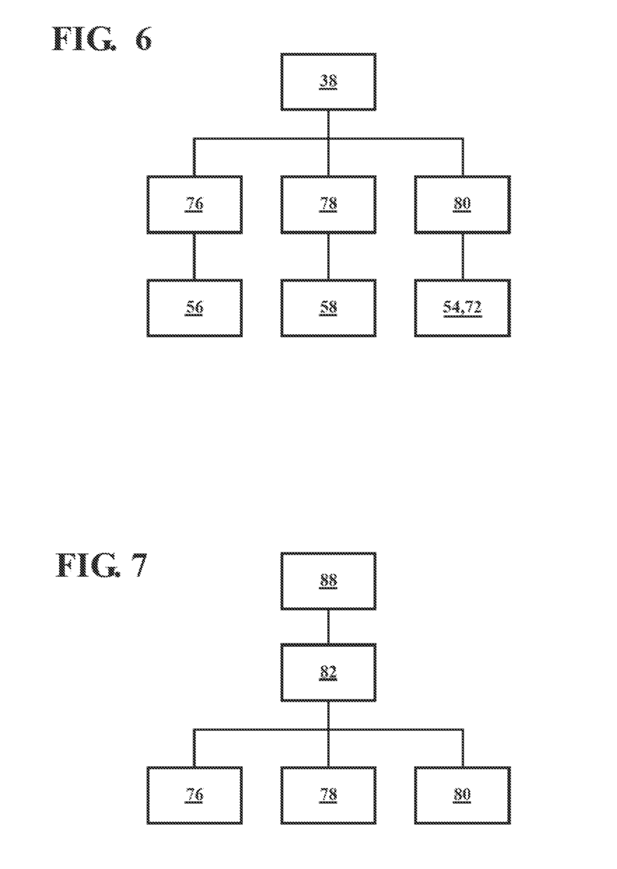

Turning to FIGS. 2 and 4-6, the power inverter module 30 can include a first inverter 76 electrically connected to the first motor/generator 56 for delivering or supplying alternating current energy to the first motor/generator 56 through the second junction 40. The power inverter module 30 can further include a second inverter 78 electrically connected to the second motor/generator 58 for delivering or supplying alternating current energy to the second motor/generator 58 through the second junction 40. Specifically, the alternating current energy is delivered to the first and second motor/generators 56, 58 through the interface assembly 66. Therefore, the direct current energy from the first cable harness 50 is converted into the alternating current energy in the first and second inverters 76, 78. As such, the first cable harness 50 is coupled to the first and second inverters 76, 78 through the first junction 38. Thus, the first and second inverters 76, 78 are electrically connected to the first junction 38. It is to be appreciated that the first and second inverters 76, 78 are shown schematically in the power inverter module 30 of FIGS. 2, 4 and 5 for illustrative purposes only and the configuration/location of the first and second inverters 76, 78 can change. It is to also be appreciated that some of the electrical connections are shown in FIGS. 2 and 5.

In addition, the power inverter module 30 can include a third inverter 80 electrically connected to the motor 72 of the pump 54 for delivering or supplying alternating current energy to the motor 72 of the pump 54 through the third junction 42. Specifically, the alternating current energy is delivered to the motor 72 of the pump 54 through the third junction 42 and the second cable harness 74. Therefore, the direct current energy from the first cable harness 50 is converted into the alternating current energy in the third inverter 80. As such, the first cable harness 50 is coupled to the third inverter 80 through the first junction 38. Thus, the third inverter 80 is electrically connected to the first junction 38. It is to be appreciated that the third inverter 80 is shown schematically in the power inverter module 30 of FIGS. 2, 4 and 5 for illustrative purposes only and the configuration/location of the third inverter 80 can change. As discussed above, it is to also be appreciated that some of the electrical connections are shown in FIGS. 2 and 5.

Furthermore, referring to FIGS. 2 and 4-7, the power inverter module 30 can include a controller 82 coupled to at least one of the first, second and third inverters 76, 78, 80 for controlling at least one of the motor 72 of the pump 54 and the first and second motor/generators 56, 58. In certain embodiments, the controller 82 is coupled to the first, second and third inverters 76, 78, 80 for controlling the first and second motor/generators 56, 58 and the motor 72 of the pump 54. In other words, the controller 82 is in communication with the first, second and third inverters 76, 78, 80. It is to be appreciated that the controller 82 is shown schematically in the power inverter module 30 of FIGS. 2 and 4 for illustrative purposes only and the configuration/location of the controller 82 can change. It is to further be appreciated that more than one controller 82 can be disposed in the power inverter module 30. It is to also be appreciated that some of the connections are shown in FIGS. 4 and 5.

The first, second and third inverters 76, 78, 80 are each disposed in the self-contained unit. Furthermore, the controller 82 is disposed in the self-contained unit. In other words, the controller 82, and the first, second and third inverters 76, 78, 80 are each disposed in the hollow of the power inverter module 30. Therefore, the controller 82, and the first, second and third inverters 76, 78, 80 are disposed within the bottom 32 and the cover 34 of the power inverter module 30. As such, packaging of the controller 82 and the first, second and third power inverters 76, 78, 80 in the self-contained unit of the power inverter module 30 provides a compact design, as well as provides easy assembly of the power inverter module 30 to the transmission 10 and easy disassembly of the power inverter module 30 from the transmission 10. Therefore, the power inverter module 30 is self-contained to be integrated into the transmission 10, thus simplifying assembly. As such, the configuration of the casing 12 can be consistent or the same and which can be utilized in multiple different vehicles. As such, the configuration of the casing 12 can be consistent or the same, and thus provide one configuration of the casing 12 that can be used in multiple different vehicles.

Once the power inverter module 30 is disposed in the first cavity 22, various wires, lines, bolts, clips, attachment points, etc. are connected to the power inverter module 30 before attaching the lid 36 to the casing 12. Again, integrating the power inverter module 30 into the transmission 10 reduces the number of assembly components and thus simplifies assembly of the transmission 10.

Referring to FIG. 2, the lid 36 can also define a second opening 84 spaced from the first opening 52 such that a wire harness 86 (see FIG. 1) is electrically connected to at least one of the controller 82 and the first, second and third inverters 76, 78, 80. More specifically, the wire harness 86 connects the controller 82 to other vehicle systems such that the controller 82 can communicate with other vehicle systems. It is to be appreciated that the first and second cable harnesses 50, 74 and the wire harness 86 are shown schematically for illustrative purposes.

A connection plug 88 (see FIGS. 1 and 2) can extend from the power inverter module 30 and cooperates with the second opening 84 and the wire harness 86 such that the wire harness 86 can engage the connection plug 88. Furthermore, the connection plug 88 and the controller 82 are in communication with each other (see FIGS. 2 and 7). Therefore, the wire harness 86 is coupled to the controller 82 through the connection plug 88 such that the wire harness 86 and the controller 82 are in communication with each other. In certain embodiments, the connection plug 88 extends from the top side 48 of the cover 34 of the power inverter module 30. Specifically, the wire harness 86 generally closes or seals the lid 36 about the second opening 84 to minimize fluids, particles, etc. from entering the first cavity 22 from outside of the lid 36. It is to be appreciated that other components can be utilized to close or seal the lid 36 about the second opening 84, such as, for example, seals, gaskets, caps, etc. It is to further be appreciated that the connection plug 88 can extend from any suitable side, including the front, rear and top sides 44, 46, 48 as discussed above, of the power inverter module 30.

It is to be appreciated that various components have been removed from FIG. 2 for illustrative purposes only, for example, fasteners for attaching or securing the lid 36 to the casing 12 has been removed, as well as the first cable harness 50 and the wire harness 86 have been removed. It is to also be appreciated that not all of the components have been exploded in FIG. 2 for illustrative purposes only, for example, the first and second bundles 68, 70 are not exploded.

While the best modes for carrying out the disclosure have been described in detail, those familiar with the art to which this disclosure relates will recognize various alternative designs and embodiments for practicing the disclosure within the scope of the appended claims.

1. A transmission for a vehicle, the transmission comprising:
a casing including a base and a plurality of walls extending outwardly away from the base to a distal edge, with the casing defining a first cavity and a second cavity between the walls;
a platform disposed between the walls to separate the first and second cavities, with the first cavity disposed adjacent to the distal edge of each of the walls; and
a power inverter module defining a self-contained unit selectively disposed in the first cavity, with the self-contained unit supported by the platform when in the first cavity.

2. A transmission as set forth in claim 1 wherein the power inverter module includes a bottom selectively coupled to the platform and a cover coupled to the bottom, with the bottom and the cover cooperating to further define the self-contained unit.

3. A transmission as set forth in claim 1 further including a lid attached to the casing to contain the power inverter module inside the first cavity.

4. A transmission as set forth in claim 3 wherein the lid is movable between a first position attached to the distal edge of each of the walls for containing the power inverter module in the first cavity of the casing and a second position detached from the distal edge of each of the walls for removing the power inverter module from the first cavity of the casing as the self-contained unit.

5. A transmission as set forth in claim 1 wherein the second cavity is configured for receiving a liquid fluid to define a wet interior.

6. A transmission as set forth in claim 5 wherein the liquid fluid in the second cavity is transmission fluid.

7. A transmission as set forth in claim 5 wherein the first cavity is generally disposed above the second cavity for maintaining the liquid fluid in the second cavity such that the first cavity defines a dry interior.

8. A transmission as set forth in claim 1 wherein the power inverter module is configured for converting direct current energy into alternating current energy.

9. A transmission as set forth in claim 8 wherein the power inverter module includes a first junction for receiving the direct current energy into the self-contained unit and wherein the power inverter module includes a second junction and a third junction each for outputting the alternating current energy from the self-contained unit.

10. A transmission as set forth in claim 9 further including at least one of a pump and a first motor/generator electrically connected to one of the second and third junctions of the power inverter module such that the alternating current energy is delivered to at least one of the pump and the first motor/generator.

11. A transmission as set forth in claim 10 wherein the first motor/generator is disposed in the second cavity, and further including a second motor/generator disposed in the second cavity, with the first and second motor/generators each electrically connected to the second junction of the power inverter module such that the alternating current energy is delivered to the first and second motor/generators.

12. A transmission as set forth in claim 11 wherein the pump includes a motor electrically connected to the third junction of the power inverter module such that the alternating current energy is delivered to the motor of the pump.

13. A transmission as set forth in claim 12 wherein the power inverter module includes a first inverter electrically connected to the first motor/generator for delivering alternating current energy to the first motor/generator through the second junction, a second inverter electrically connected to the second motor/generator for delivering alternating current energy to the second motor/generator through the second junction, and a third inverter electrically connected to the motor of the pump for delivering alternating current energy to the motor of the pump through the third junction, with the first, second and third inverters disposed in the self-contained unit.

14. A transmission as set forth in claim 13 wherein the power inverter module includes a controller disposed in the self-contained unit and coupled to the first, second and third inverters for controlling the first and second motor/generators and the motor of the pump.

15. A transmission for a vehicle; the transmission comprising:
a casing including a base and a plurality of walls extending outwardly away from the base to a distal edge, with the casing defining a first cavity and a second cavity between the walls;
wherein the walls include an exterior disposed outside of the casing;
wherein the second cavity is configured for receiving transmission fluid to define a wet interior, with the first cavity generally disposed above the second cavity for maintaining the transmission fluid in the second cavity such that the first cavity defines a dry interior;
a platform disposed between the walls to separate the first and second cavities, with the first cavity disposed adjacent to the distal edge of each of the walls such that the first cavity is selectively open to the exterior of the walls and the second cavity is closed to the exterior of the walls;
a power inverter module defining a self-contained unit selectively disposed in the first cavity, with the self-contained unit supported by the platform when in the first cavity; and
a lid movable between a first position attached to the distal edge of each of the walls for containing the power inverter module in the first cavity of the casing and a second position detached from the distal edge of each of the walls for removing the power inverter module from the first cavity of the casing as the self-contained unit.

16. A transmission as set forth in claim 15 wherein the power inverter module includes a bottom selectively coupled to the platform and a cover coupled to the bottom, with the bottom and the cover cooperating to further define the self-contained unit.

17. A transmission as set forth in claim 15 wherein the power inverter module is configured to convert direct current energy into alternating current energy, and wherein the power inverter module includes a first junction for receiving the direct current energy into the self-contained unit, and wherein the power inverter module includes a second junction and a third junction each for outputting the alternating current energy from the self-contained unit.

18. A transmission as set forth in claim 17 further including a first motor/generator and a second motor/generator each disposed in the second cavity, with the first and second motor/generators each electrically connected to the second junction of the power inverter module such that the alternating current energy is delivered to the first and second motor/generators, and wherein the pump includes a motor electrically connected to the third junction of the power inverter module such that the alternating current energy is delivered to the motor of the pump.

19. A transmission as set forth in claim 18 wherein the power inverter module includes a first inverter electrically connected to the first motor/generator for delivering alternating current energy to the first motor/generator through the second junction, a second inverter electrically connected to the second motor/generator for delivering alternating current energy to the second motor/generator through the second junction, and a third inverter electrically connected to the motor of the pump for delivering alternating current energy to the motor of the pump through the third junction, with the first, second and third inverters disposed in the self-contained unit.

20. A transmission as set forth in claim 19 wherein the power inverter module includes a controller disposed in the self-contained unit and coupled to the first, second and third inverters for controlling the first and second motor/generators and the motor of the pump.
